(19) United States
(12) Patent Application Publication
(10) Pub. No.: US 2016/0025883 A1
(43) Pub. Date: Jan. 28, 2016

(54) SUBMERGED HUB FOR OCEAN BOTTOM SEISMIC DATA ACQUISITION

(71) Applicant: ION GEOPHYSICAL CORPORATION, Houston, TX (US)

(72) Inventors: Dale J. LAMBERT, Mandeville, LA (US); Felix E. BIRCHER, Metairie, LA (US)

(21) Appl. No.: 14/774,369

(22) PCT Filed: Mar. 11, 2014
(86) PCT No.: PCT/US14/23014

§ 371 Date: Sep. 10, 2015

Related U.S. Application Data
(60) Provisional application No. 61/776,156, filed on Mar. 11, 2013.

(51) Int. Cl. G01V 1/38; G01V 1/20

(52) U.S. Cl. CPC G01V 1/3852; G01V 1/20; G01V 1/3808

(57) ABSTRACT

Embodiments of the invention provide methods, systems, and apparatus for collecting seismic data in marine environments. An ocean bottom cable comprising a plurality of sensor nodes for collecting seismic data may be coupled to a submerged hub. The submerged hub may provide seismic data storage, power, clock, and other support for operating the sensor nodes. By providing a submerged hub, the ocean bottom cable may continue collecting seismic data in harsh environments such as the arctic, where the sea surface may be frozen.

### CROSS REFERENCE TO RELATED APPLICATIONS

This application claims priority to and the benefit of PCT application number PCT/US2014/023014, entitled “Submerged Hub for Ocean Bottom Seismic Data Acquisition,” which was filed on Mar. 11, 2014, and also claims priority to and the benefit of U.S. provisional application No. 61/776,156, entitled “Submerged Hub for Ocean Bottom Seismic Data Acquisition,” which was filed on Mar. 11, 2013, both of which are hereby incorporated by reference in their entirety for all purposes.

### BACKGROUND

1. Field

The present invention generally relates to seismic data acquisition, and more specifically to ocean bottom seismic data acquisition systems.

2. Description of the Related Art

In conventional marine seismic surveying, a vessel tows a seismic source, such as an airgun array, that periodically emits acoustic energy into the water to penetrate the seabed. Sensors, such as hydrophones, geophones, and accelerometers may be housed in sensor units at sensor nodes periodically spaced along the length of an ocean bottom cable (OBC) resting on the seabed. The sensors of the sensor node are configured to sense acoustic energy reflected off boundaries between layers in geologic formations. Hydrophones detect acoustic pressure variations; geophones and accelerometers, which are both motion sensors, sense particle motion caused by the reflected seismic energy. Signals from these kinds of sensors are used to map the geologic formations.

The power required to operate the sensor nodes may be provided via batteries and/or power generators. For example, in OBC systems, the cable may be connected to a surface buoy or a seismic vessel comprising a generator, e.g., a diesel generator. The generator may provide power for operating the sensors either directly or indirectly (e.g., via chargeable batteries included in the sensor nodes).

### SUMMARY

The present invention generally relates to seismic data acquisition, and more specifically to ocean bottom seismic data acquisition systems.

One embodiment of the invention provides a seismic data acquisition system, generally comprising an ocean bottom cable comprising a plurality of sensor nodes, and a hub device coupled to the ocean bottom cable, wherein the hub device is positioned at or near a predefined location below the water surface.

Another embodiment of the invention provides a submerged hub device, generally comprising an interface configured to couple the submerged hub device to an ocean bottom cable comprising a plurality of sensor nodes for collecting seismic data, memory storage for storing the seismic data collected by the plurality of sensor nodes, a power system configured to power the submerged hub device and the plurality of sensor nodes, and a depth control device configured to position the submerged hub at a predefined location below the water surface.

Yet another embodiment of the invention provides a method for deploying a seismic data acquisition system. The method generally comprises initiating deployment of an ocean bottom cable at a bottom of a body of water, attaching an anchor at a predefined location along the ocean bottom cable, coupling an end of the ocean bottom cable to a submerged hub device, and releasing the submerged hub device in the body of water, wherein the submerged hub device is configured to float a predefined distance above the bottom of the body of water, the predefined distance being defined, at least in part, by a length of a portion of the ocean bottom cable between the anchor and the submerged hub device.

A further embodiment of the invention provides a method for deploying a seismic data acquisition system. The method generally comprises initiating deployment of an ocean bottom cable at a bottom of a body of water, coupling an end of the ocean bottom cable to a submerged hub device, releasing the submerged hub device in the body of water, and adjusting a depth control device such that the submerged hub is positioned at a predefined location in the body of water.

Another embodiment of the invention provides a method for retrieving an ocean bottom seismic data acquisition system comprising an ocean bottom cable coupled with a submerged hub device. The method generally comprises generating a signal from a vessel, the signal indicating a retrieval operation, in response to the signal, deploying a float device from the submerged hub to a surface of a body of water comprising the ocean bottom seismic data acquisition system, and retrieving the ocean bottom seismic data acquisition system by locating the float device.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an example of a seismic survey according to an embodiment of the invention.

FIG. 2 is an example of a seismic survey according to another embodiment of the invention.

FIG. 3 illustrates a hub device according to an embodiment of the invention.

FIGS. 4A-D illustrate deployment of a seismic data acquisition system according to an embodiment of the invention.

FIGS. 5A-C illustrate deployment of a seismic data acquisition system according to another embodiment of the invention.

FIG. 6 illustrates retrieval of a seismic data acquisition system according to an embodiment of the invention.

FIGS. 7A-B illustrate retrieval of a seismic data acquisition system according to an embodiment of the invention.

### DETAILED DESCRIPTION

Embodiments of the invention provide methods, systems, and apparatus for collecting seismic data in a marine environment. An ocean bottom cable comprising a plurality of sensor nodes for collecting seismic data may be coupled to a submerged hub. The submerged hub may provide seismic data storage, power, clock, and other support for operating the sensor nodes. By providing a submerged hub, the ocean bottom cable may continue collecting seismic data in harsh environments such as the arctic, where the sea surface may be frozen.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computerized system. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a wireless network. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Furthermore, while reference is made to a sea floor and seabed herein, embodiments of the invention are not limited to use in a sea environment. Rather, embodiments of the invention may be used in any marine environment including oceans, lakes, rivers, etc. Accordingly, the use of the term sea, seabed, sea floor, and the like, hereinafter should be broadly understood to include all bodies of water.

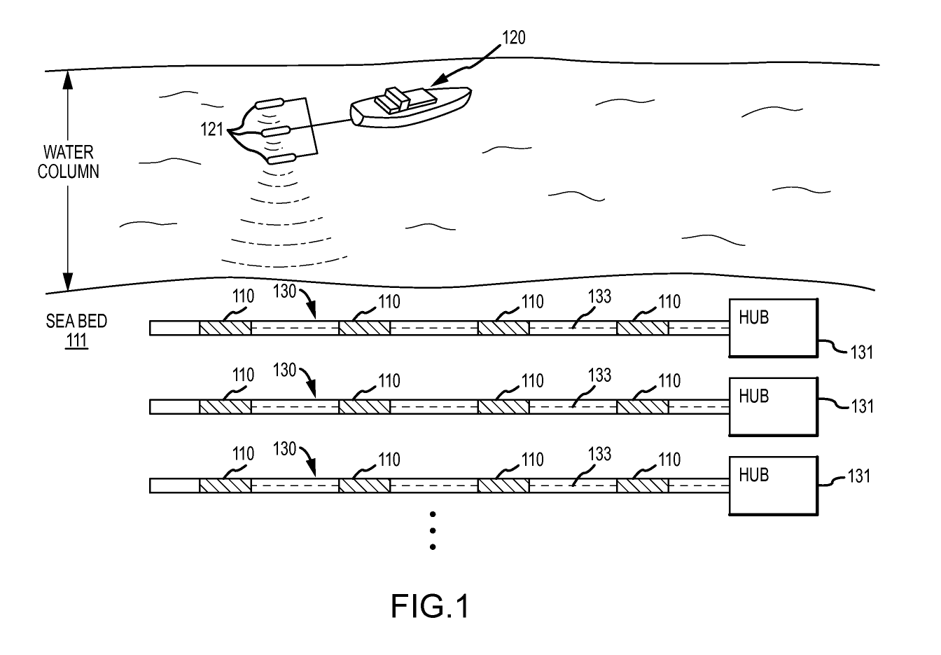

FIG. 1 illustrates an exemplary seismic survey according to an embodiment of the invention. As illustrated in FIG. 1, a source boat 120 may be configured to tow at least one seismic source 121 while conducting a seismic survey. In one embodiment, the seismic source 121 may be an air gun configured to release a blast of compressed air into the water column towards the seabed 111. As shown in FIG. 1, the blast of compressed air generates seismic waves 122 which may travel down towards the seabed 111, and penetrate and/or reflect from sub-seabed surfaces. The reflections from the sub-surfaces may be recorded by sensor nodes 110 as seismic data, which may be thereafter processed to develop an image of the sub-surface layers. These images may be analyzed by geologists to identify areas likely to include hydrocarbons or other substances of interest.

As illustrated in FIG. 1, a plurality of sensor nodes 110 may be placed in each of one or more ocean bottom cable assemblies (OBCs) 130. The OBCs may be coupled to a respective sub-sea hub device 131 (referred to hereinafter simply as “hub”), as illustrated in FIG. 1. In one embodiment, the hubs 131 may be placed on the seabed 111, as shown. The hubs 131 may include seismic data storage systems configured to store seismic data collected by the sensor nodes 110, a power system, etc., as will be described in greater detail below.

While the sensor nodes 110 are depicted as being enclosed within an ocean bottom cable skin, in alternative embodiments, the sensor nodes 110 may not be enclosed as shown. In such alternative embodiments, the sensor nodes may be independent distinct devices exposed to the water, and may be strung together via a single cable or cable segments. Accordingly, reference to the term “ocean bottom cable” herein refers to any reasonable arrangement of sensor nodes wherein a plurality of sensor nodes are physically coupled to each other, whether or not they are enclosed in a cable skin.

As illustrated in FIG. 1, a link system 133 (hereinafter referred to simply as “link”) may transfer power, data, instructions, and the like from the hub 131 to the sensor nodes 110. In one embodiment, the link 133 may include a plurality of transmission lines. For example, a first plurality of transmission lines may be configured to transfer data between the sensor nodes and the hub, a second plurality of data lines may be configured to transfer instructions between the sensor nodes and the hub, and a third one or more transmission lines may transfer power from the hub to the sensor nodes. In alternative embodiments, the same set of transmission line or lines may be used to transfer one or more of seismic data, instructions, and/or power. Moreover, while a single link 133 is referred to herein, in alternative embodiments, a plurality of links may be included to transfer the seismic data, instructions, and power between the sensor nodes 110 and respective hubs 131.

In one embodiment of the invention, the sensor nodes 110 may be coupled to each other serially. Therefore, each node may be configured to receive and transfer instructions, data, power, etc. from a first node to a second node. In an alternative embodiment, the sensor nodes 110 may be connected in parallel via the link 133. In other words, one or more of the plurality of sensor nodes 110 may be directly coupled to the hub 131 via the link 133. In other embodiments, the sensor nodes may be connected in any combination of serial and parallel connections with respect to each other, and direct and indirect coupling with the surface buoy.

While the link 133 is shown herein as a physical link, in alternative embodiments, the link 133 may be a wireless link. For example, communications between the sensor nodes and the hub devices may be performed using acoustic signals, electromagnetic signals, and the like. Furthermore, while each cable 130 is shown to be coupled with its own respective hub 131 in FIG. 1, in alternative embodiments, multiple cables 130 may be coupled to a single hub 131.

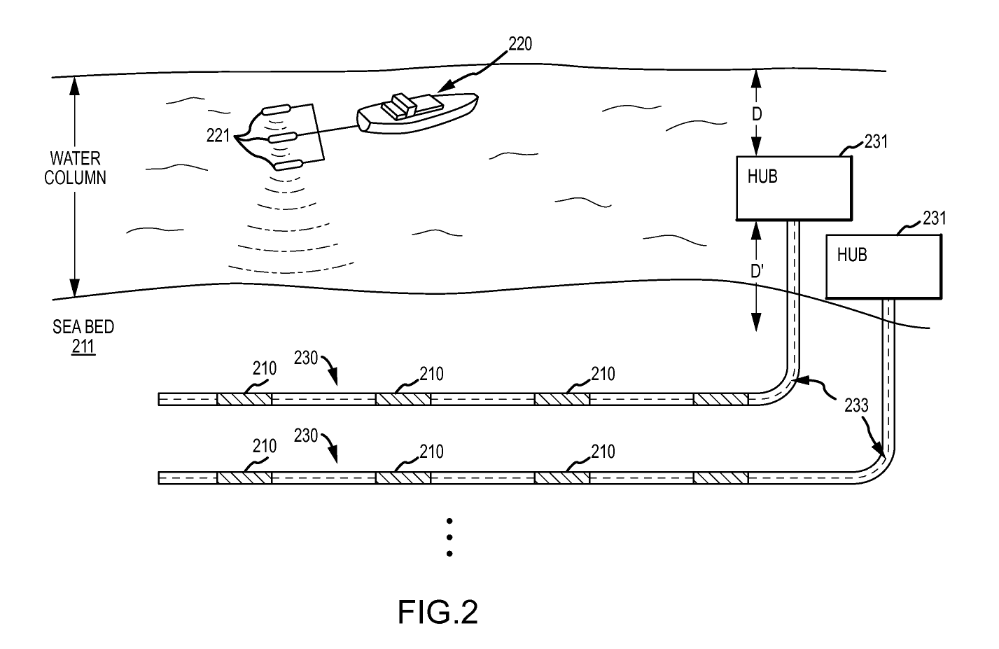

FIG. 2 illustrates yet another seismic survey according to another embodiment of the invention. Similar to FIG. 1, the seismic survey shown in FIG. 2 may also include a source boat 220 towing one or more seismic sources 221 and a plurality of ocean bottom cables 230, each comprising a plurality of nodes 210. In contrast to FIG. 1, however, the ocean bottom cables 230 may be coupled to a floating hub 231 instead of an ocean bottom hub (as shown in FIG. 1). In particular, the hub 231 may be configured to float at a predefined distance D′ above the sea floor or a predefined distance D below the water surface.

The use of sub-sea hubs, such as the sub-sea hub 131 of FIG. 1 and the sub-sea hub 231 of FIG. 2, may be particularly advantageous in environments such as the arctic, where the sea surface may be frozen and/or may include moving masses of ice which may crash into and destroy equipment that may be floating on the sea surface. By allowing the ocean bottom cable and the hub device to remain safely below the sea surface, seismic data collection operations may continue even during times when the sea surface is frozen by using an ice breaking ship and/or a source boat, which may operate at the surface.

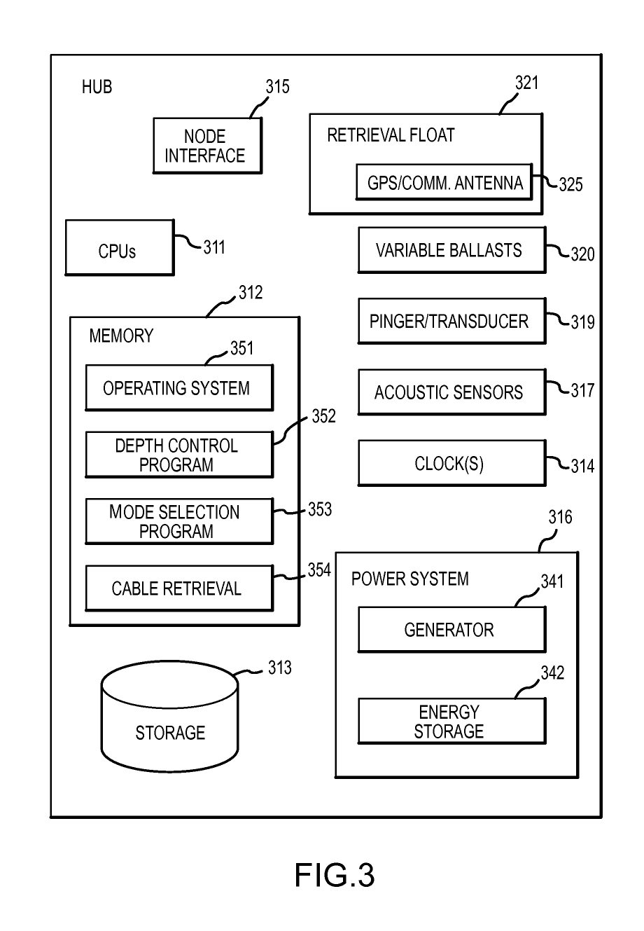

FIG. 3 is a detailed view of a sub-sea hub 300 according to an embodiment of the invention. The hub 300 may be an example of the hub 131 and hub 231 illustrated in FIGS. 1 and 2, respectively. As illustrated in FIG. 3, the hub 300 may include any combination of one or more of a Central Processing Unit (CPU) 311, a memory 312, storage 313, one or more high precision clocks 314, and a node interface 315, a power generation system 316, acoustic sensors 317, acoustic source 318, a pinger/transducer 319, variable ballasts 320, and retrieval float 321.

The CPU 311 may be configured to perform arithmetic, logical and input/output operations in response to instructions of a program contained in the memory 312. While a single CPU 311 is shown in FIG. 3, in alternative embodiments, a plurality of CPUs may be implemented within the hub 300. Storage 313 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 312 and storage 313 could be part of one virtual address space spanning multiple primary and secondary storage devices.

The clock 314 may be utilized to determine the arrival times of various acoustic signals at one or more sensor nodes. While a single clock is shown, in alternative embodiments, any number and types of clocks may be included in the hub 300. For example, in one embodiment, the hub 300 may include a high precision clock and/or a low precision clock. The high precision clock may be used to operate the sensor node in an acquisition or active mode, and the low precision clock may be used to operate the device in an idle or sleep or power savings mode.

The node interface device 315 may be any entry/exit device configured to facilitate network communications between the hub 300 and one or more nodes, for example, via a communications link (see links 133 and 233 in FIGS. 1 and 2, respectively). In one embodiment, the node interface device 315 may be a network adapter or other network interface card (NIC). The node interface device may be used to transfer instructions and data between the hub 300 and one or more nodes. For example, in one embodiment, seismic data may be received from the nodes via the network interface 315 and stored in the storage device 313. The node interface 315 may also be used to share the clock signal from the clock 314 of hub 300 to one or more nodes connected thereto. In one embodiment, the node interface may be used to transfer instructions to put one or more nodes in a sleep mode or active mode, as is described in co-pending U.S. provisional application No. 61/775,915, filed on Mar. 11, 2013, and titled POWER SAVINGS MODE FOR OCEAN BOTTOM SEISMIC DATA ACQUISITION SYSTEMS, which is incorporated by reference herein in its entirety.

The power system 316 may include a power generator 341 and/or an energy storage system 342. The power generator 341 can be any type of power generator, for example, a diesel generator, methane generator, and the like. The energy storage system 342, in one embodiment, may be a rechargeable battery system including one or more batteries made from, e.g., nickel-cadmium (NiCd), nickel-zinc (NiZn), nickel metal hydride (NiMH), and/or lithium-ion (Li-ion) based cells. In an alternative embodiment, the energy storage system may include a fuel cell. Exemplary fuels that may be used as fuel in the fuel cell include hydrogen, hydrocarbons such as natural gas or diesel, and alcohols such as methanol. In some embodiments, a combination of different types of energy storage systems may be integrated within the energy storage system 342. In general, the power generated by the generator 341 and/or the power stored in the energy storage system 342 may be used to power the hub 300 and one or more sensor nodes connected thereto either directly or indirectly by recharging energy storage systems included in the sensor nodes.

The acoustic sensors 317 may facilitate communications between the hub 300 and a source boat. Such communication may be necessary during deployment and retrieval of the hub and associated ocean bottom cables, as will be discussed in greater detail below.

The pinger/transducer 319 and retrieval float 321 may be devices to facilitate locating and/or retrieving the hub 300. For example, the pinger/transducer may be configured to generate an acoustic signal (or “ping”) so that a nearby vessel is able to zero in on a location of the hub 300. The retrieval float 321 may be a reel-able float that is deployed to the sea surface from the sub-sea position of the hub 300 to facilitate determining a location of the hub or to facilitate communications between the hub and a vessel. As illustrated in FIG. 3, the retrieval float 321 may include GPS or other communication antenna 325 to further assist with locating the hub 300.

Variable ballasts 320 may be configured to position the hub 300 at or near a predefined depth. The variable ballasts 320 may generally comprise one or more tanks configured to hold either air, water, or a combination of air and water. By adjusting the amount of water in the ballast tanks, the buoyancy of the hub 300 may be altered, thereby allowing the hub to dive, resurface, or position the hub at a predefined depth, for example, the depth D or D′ illustrated in FIG. 1.

The memory 312 is preferably a random access memory sufficiently large to hold the necessary programming and data structures of the invention. While memory 312 is shown as a single entity, it should be understood that memory 312 may in fact comprise a plurality of modules, and that memory 312 may exist at multiple levels, from high speed registers and caches to lower speed but larger DRAM chips.

Illustratively, the memory 312 contains an operating system 351. Illustrative operating systems, which may be used to advantage, include Linux (Linux is a trademark of Linus Torvalds in the US, other countries, or both). More generally, any operating system supporting the functions disclosed herein may be used.

Memory 312 is also shown containing a depth control program 352. The depth control program may be configured to operate one or more devices related to the deployment, retrieval, and positioning of the hub 300, according to one embodiment. For example, the depth control program may be configured to control the amount of water that is in the variable ballasts 320 such that the hub 300 is maintained at a desired position in the water column. During retrieval, the depth control program may cause at least some of the water in the ballasts to be expelled, so that the hub 300 floats to the surface for retrieval.

The mode selection program 353 may be configured to instruct one or more nodes associated with the hub 300 to operate in one of a power savings mode and an active mode in order to conserve power. The selection of the mode is described in greater detail in in the co-pending U.S. provisional application No. 61/775,915, filed on Mar. 11, 2013, and titled POWER SAVINGS MODE FOR OCEAN BOTTOM SEISMIC DATA ACQUISITION SYSTEMS, which is incorporated by reference herein in its entirety.

The cable retrieval program 354 may be configured to facilitate operations to retrieve the hub 300 and corresponding ocean bottom cable by assisting a retrieving vessel to locate the hub 300. For example, the cable retrieval program may cause the retrieval float 321 to be deployed to the sea surface to facilitate communication with the vessel (or to transmit a GPS signal), or cause the pinger/transducer to generate a signal or “ping” so that the hub 300 may be found. While the mode operating system 351, depth control program 352, mode selection program 353, and cable retrieval program 354 are shown as being separate from the operating system 351 in FIG. 3, in alternative embodiments, these programs may be a part of the operating system, or another program. In general, any one or more of these programs may be grouped together and/or be a smaller part of a larger program to operate the hub 300.

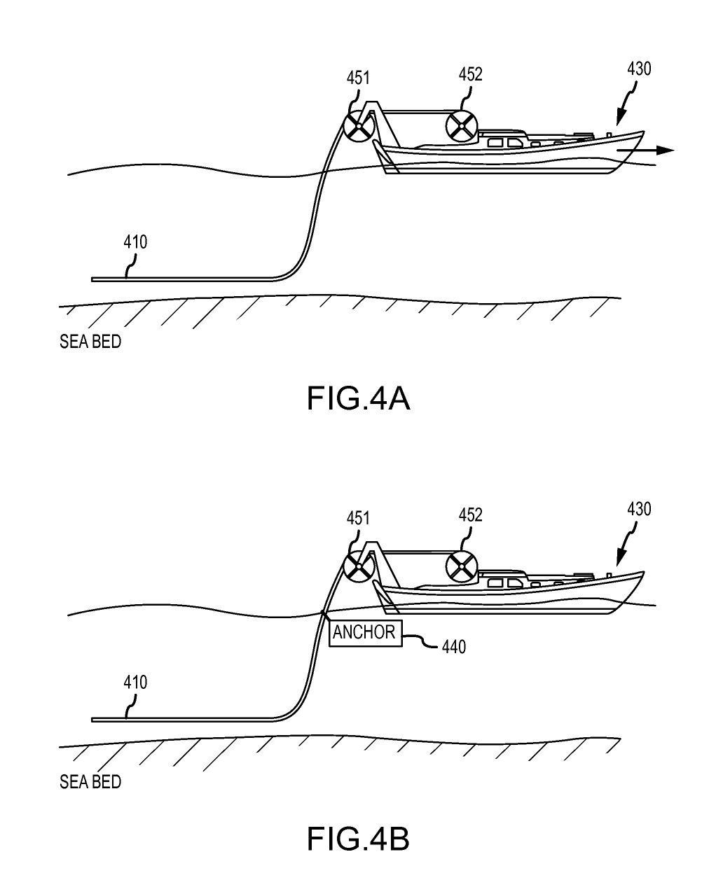

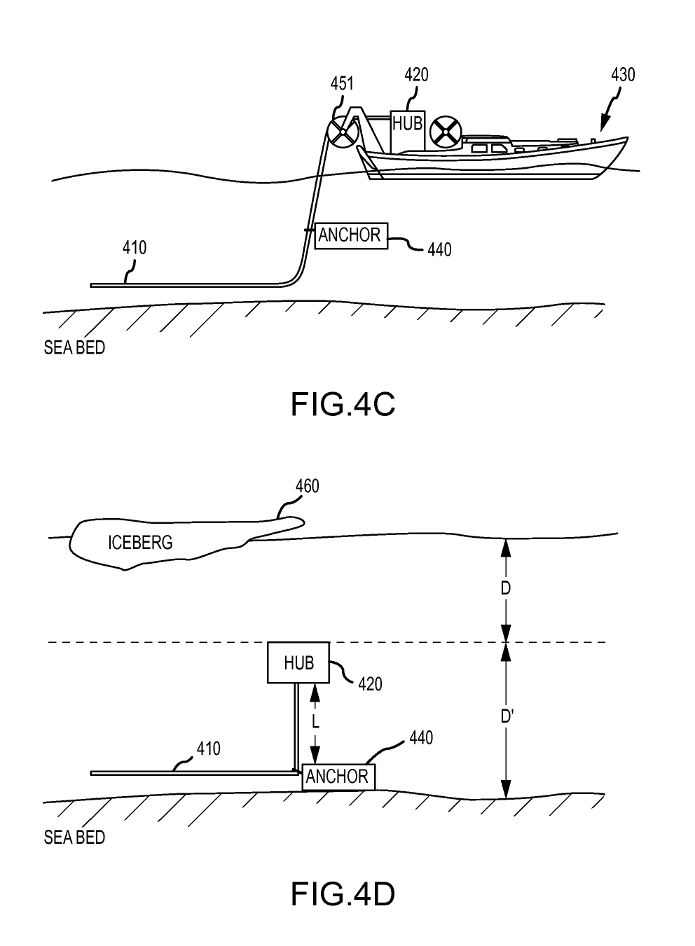

FIGS. 4A-D illustrate an exemplary method for deploying an ocean bottom cable 410 and a hub device 420 according to an embodiment of the invention. As illustrated in FIG. 4A, the deployment operations may begin by laying an ocean bottom cable 410 on the sea bed from a vessel 430. In one embodiment, laying the ocean bottom cable 410 may involve using winch devices 451 and 452 which unroll the ocean bottom cable 410 as the vessel 430 moves. As illustrated in FIG. 4B, an anchor 440 may be attached to the cable 410 and lowered into the water. The anchor 440 may be any size and/or shape, and may include a single mass or a plurality of masses coupled to each other and/or to the cable 40. For example, in one embodiment, the anchor may be a heavy metal chain.

After attaching the anchor 440, an end of the ocean bottom cable may be coupled to the hub device 420, as shown in FIG. 4C. Thereafter, the hub device 420 may also be lowered into the water. In one embodiment, the hub device 420 may be configured float in the water. However, because the hub 425200 is coupled to the anchor 440 via the cable 410, the hub 420 may sink below the sea surface. In one embodiment, the length L of the cable 410 between the hub device 420 and the anchor 440 may be selected such that the hub 420 is lowered to a depth D below the sea surface (or a depth D′ from the sea bed), as illustrated in FIG. 4D. As further illustrated in FIG. 4D, placing the hub 420 below the sea surface allows the hub to operate even when icebergs such as the iceberg 460 are present at the sea surface.

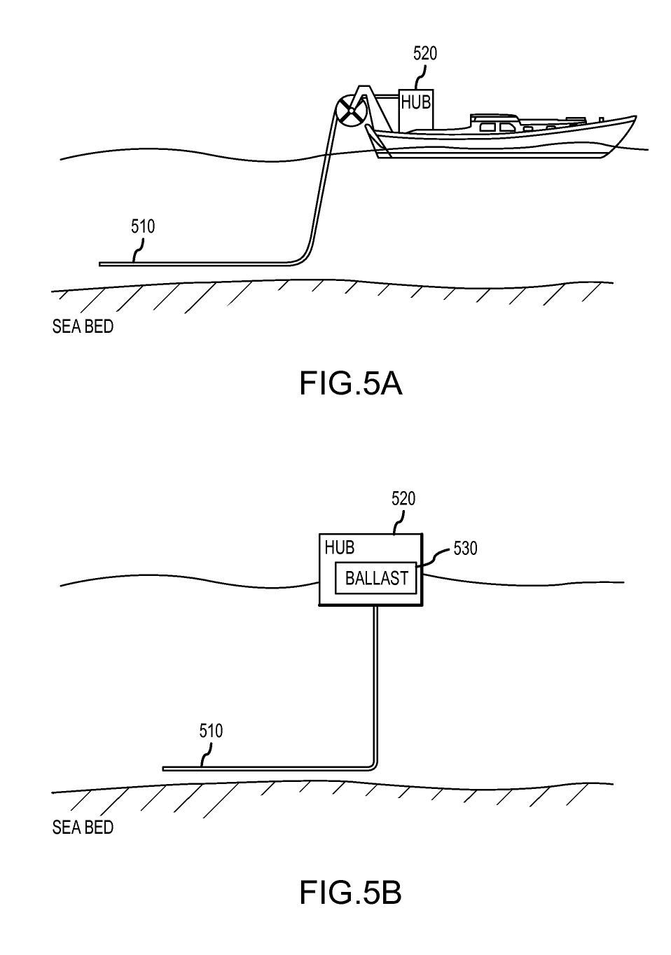

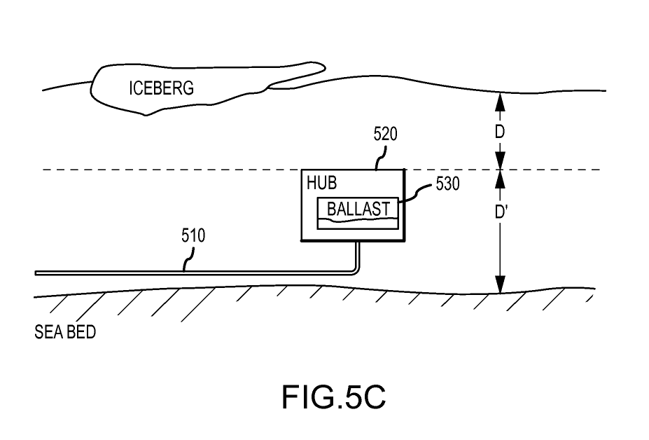

FIGS. 5A-C illustrate an alternative method for deploying an ocean bottom cable 510 and hub device 520 according to an embodiment of the invention. Deployment operations may begin as shown in FIG. 4A by laying an ocean bottom cable 510 on the sea bed. Thereafter, an end of the cable 510 may be coupled to the hub 520, as illustrated in FIG. 5A. FIG. 5B illustrates one embodiment of the invention, wherein the hub 520 is initially configured to float on the sea surface. This may occur because, for example, a ballast 530 within the hub may include mostly air and little or no water, thereby making the hub buoyant. In an alternative embodiment, the hub may be configured to sink at least partially into the water column when initially deployed. After the hub has been released in the water, the amount of water in the ballast 530 may be adjusted such that the hub 520 is positioned at or near a distance D from the sea surface or a distance D′ from the sea bed, as illustrated in FIG. 5C.

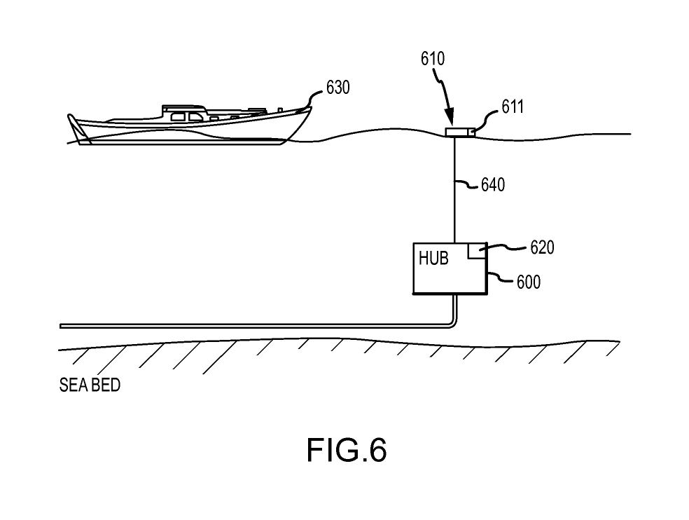

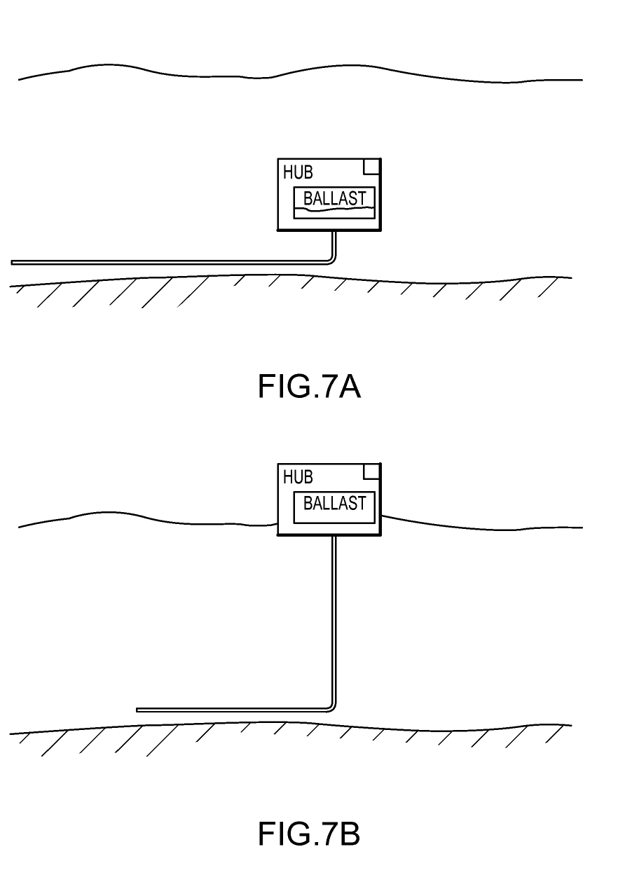

FIG. 6 illustrates an exemplary method for retrieving a hub 600, according to an embodiment of the invention. In one embodiment, the hub 600 may be configured to receive a signal from a hub-retrieving vessel 630 that is near the hub 600. The signal may be an acoustic signal, electromagnetic signal, or the like having predefined characteristics such as amplitude, frequency, sequence, and the like. Upon receiving the signal, a program, such as the cable retrieval program 354 (See FIG. 3) of the hub 600 may cause the hub to release a retrieval float 610 (see also element 321 in FIG. 3) to the surface. The retrieval float 610 may include a GPS transmitter or other communication device 611 that may communicate with the hub-retrieving vessel 630, thereby allowing the location of the hub 600 to be determined.

In one embodiment, in response to receiving a predefined signal from the cable retrieving vessel 630, the hub 600 may initiate regular “pinging” or emission of a location signal by a pinger/transducer 620. Such location signal may be received by the vessel thereby directing it towards the hub 600.

In one embodiment, retrieving the hub 600 may include pulling the hub 600 to the surface via the float 610 and cable 640 (coupling the float 610 to the hub 600). In alternative embodiments, the surface vessel 630 may generate instructions to the hub, which may cause the depth control program 352 to adjust the one or more variable ballasts 320 (see FIG. 3) of the hub 600, thereby causing the hub to surface for retrieval.

While the foregoing is directed to embodiments of the present invention, other and further embodiments of the invention may be devised without departing from the basic scope thereof, and the scope thereof is determined by the claims that follow.

1. A seismic data acquisition system, comprising:
an ocean bottom cable comprising a plurality of sensor nodes; and
a hub device coupled to the ocean bottom cable, wherein the hub device is positioned at or near a predefined location below the water surface.

2. The seismic data acquisition system of claim 1, wherein the hub device comprises memory storage for storing seismic data collected by the sensor nodes.

3. The seismic data acquisition system of claim 1, wherein the hub device comprises a float device configured to be deployed to the water surface to facilitate retrieval of the hub device and the ocean bottom cable.

4. The seismic data acquisition system of claim 3, wherein the float device comprises at least one of a global positioning satellite (GPS) transmitter and a communications antenna.

5. The seismic data acquisition system of claim 1, further comprising an anchor coupled to the ocean bottom cable, wherein the hub device is configured to float at a predefined distance from a bottom of a water body comprising the seismic data acquisition system, wherein the predefined distance is defined by at least a length of a portion of the ocean bottom cable between the anchor and the hub device.

6. The seismic data acquisition system of claim 1, wherein the hub device comprises variable ballasts, wherein the variable ballasts are adjusted to maintain the hub device at the predefined location below the water surface.

7. The seismic data acquisition system of claim 1, wherein the hub device comprises at least one of:
a power system comprising at least one of a generator and an energy storage system; and
a clock configured to generate a clock signal,
wherein the hub device is configured to provide the clock signal and power to the plurality of sensor nodes.

8. The seismic data acquisition system of claim 1, wherein the hub device comprises a pinger device configured to generate a regular acoustic signal to facilitate retrieval of the hub device and the ocean bottom cable.

9. A submerged hub device, comprising:
an interface configured to couple the submerged hub device to an ocean bottom cable comprising a plurality of sensor nodes for collecting seismic data;
memory storage for storing the seismic data collected by the plurality of sensor nodes;
a power system configured to power the submerged hub device and the plurality of sensor nodes; and
a depth control device configured to position the submerged hub at a predefined location below the water surface.

10. The sub-sea hub device of claim 9, further comprising a float device configured to be deployed to the water surface from the predefined location below the water surface to facilitate retrieval of the submerged hub device and the ocean bottom cable.

11. The sub-sea hub device of claim 10, wherein the float device comprises at least one of a global positioning satellite (GPS) transmitter and a communications antenna.

12. The sub-sea hub device of claim 9, wherein the depth control device is a variable ballast.

13. The sub-sea hub device of claim 9, further comprising an acoustic sensor configured to facilitate communication between the submerged hub device and nearby vessels.

14. The sub-sea hub device of claim 9, wherein the interface is configured to transfer at least seismic data, power, and a clock signal between the submerged hub device and the plurality of sensor nodes.

15. A method for deploying a seismic data acquisition system, comprising:
initiating deployment of an ocean bottom cable at a bottom of a body of water;
attaching an anchor at a predefined location along the ocean bottom cable;
coupling an end of the ocean bottom cable to a submerged hub device; and
releasing the submerged hub device in the body of water, wherein the submerged hub device is configured to float a predefined distance above the bottom of the body of water, the predefined distance being defined, at least in part, by a length of a portion of the ocean bottom cable between the anchor and the submerged hub device.

16. A method for deploying a seismic data acquisition system, comprising:
initiating deployment of an ocean bottom cable at a bottom of a body of water;
coupling an end of the ocean bottom cable to a submerged hub device;
releasing the submerged hub device in the body of water; and
adjusting a depth control device such that the submerged hub is positioned at a predefined location in the body of water.

17. A method for retrieving an ocean bottom seismic data acquisition system comprising an ocean bottom cable coupled with a submerged hub device, comprising:
generating a signal from a vessel, the signal indicating a retrieval operation;
in response to the signal, deploying a float device from the submerged hub to a surface of a body of water comprising the ocean bottom seismic data acquisition system; and
retrieving the ocean bottom seismic data acquisition system by locating the float device.

18. The method of claim 17, wherein locating the float device comprises communicating with wireless transmission system located in the float device.

19. The methods of claim 18, wherein the wireless transmission system comprises at least one of a global positioning satellite transmitter and an antenna.

20. The method of claim 17, wherein retrieving the ocean bottom seismic data acquisition system comprises adjusting a depth control device in the submerged hub, thereby causing the submerged hub to surface.

21. The method of claim 17, wherein retrieving the ocean bottom seismic data acquisition system comprises pulling up the submerged hub device via the float device.
